(19) United States
(12) Patent Application Publication
(10) Pub. No.: US 2025/0114822 A1
(43) Pub. Date: Apr. 10, 2025

(54) PMUT with Plurality of Vent Holes

(71) Applicant: InvenSense, Inc., San Jose, CA (US)

(72) Inventors: Stefon Eric Shelton, Oakland, CA (US); Benjamin Eric Eovino, Oakland, CA (US); Fabian Thomas Goericke, Berkeley, CA (US)

(21) Appl. No.: 18/826,877

(22) Filed: Sep. 6, 2024

Related U.S. Application Data
(60) Provisional application No. 63/587,745, filed on Oct. 4, 2023.

(51) Int. Cl. B06B 1/06

(52) U.S. Cl. CPC B06B 1/0666; B06B 1/0651

(57) ABSTRACT

A piezoelectric micromachined ultrasonic transducer (“PMUT”) sensor has a membrane that includes an active region that actively transmits and receives ultrasonic acoustic signals and an inactive region that contributes to the PMUT modeshape but does not actively transmit and receive ultrasonic acoustic signals. A plurality of vent holes are distributed throughout the membrane such as in the inactive region. The number and size of the vent holes are selected to provide a necessary dissipation of pressure bursts or transients while maintaining a transmission efficiency.

### CROSS-REFERENCE TO RELATED APPLICATION

This application claims priority to U.S. Provisional Patent Application No. 63/587,745, filed Oct. 4, 2023, and entitled “Vent Hole Configuration and Dimensions for Ultrasonic Transducers,” which is incorporated by reference herein in its entirety for all purposes.

### BACKGROUND

Ultrasonic sensors such as a piezoelectric micromachined ultrasonic transducer (“PMUT”) sensor transmit an ultrasound signal or wave into an environment of interest and measure reflected signals that are received over time, with the timing and magnitude of the reflected or echo signal corresponding to the distance to an object of interest and the characteristics of the object causing the reflection. Accordingly, PMUT sensors are used for a variety of applications such as fingerprint sensors and object detection systems, which in turn are integrated into numerous end use devices such as security systems, door locks, computers, smart phones, tablet devices, vehicles, and the like.

A PMUT device includes a membrane that generates an ultrasonic acoustic output signal based on an electrical signal applied across a piezoelectric material layer, for example, by electrodes located on each side of the piezoelectric material layer. Similarly, an ultrasonic acoustic signal received at the piezoelectric material layer of the membrane is converted by the piezoelectric material layer to an electrical signal which is received and processed via the adjacent electrode layers. The design characteristics of the membrane such as shape, layer thicknesses, and additional support layers relate to the efficiency of the transmission and reception of ultrasonic acoustic signals. At the same time, because a PMUT typically transmits and receives signals into some external environment the membrane may be exposed to external shocks such as pressure bursts or transients that can damage the membrane.

### SUMMARY

In some examples, a piezoelectric micromachined ultrasonic transducer (PMUT) robust to an applied pressure comprises a membrane including a first electrode layer, a second electrode layer, and a piezoelectric layer between the first electrode layer and the second electrode layer, with the membrane comprising an active region configured to cause the piezoelectric layer to transmit a first ultrasonic acoustic signal based on a first electrical signal between the first electrode layer and the second electrode layer, and configured to output a second electrical signal corresponding to the first electrode layer and the second electrode layer based on a second ultrasonic acoustic signal received by the piezoelectric layer. The membrane may further comprise at least one inactive region where the first electrical signal is not applied to the piezoelectric layer. The PMUT may further comprise a plurality of vent holes that extend through the membrane and located within the at least one inactive region, wherein the plurality of vent holes balance robustness to the applied pressure and a desired ultrasonic acoustic output.

In some examples, a piezoelectric micromachined ultrasonic transducer (PMUT) robust to an applied pressure comprises a membrane including a first electrode layer, a second electrode layer, and a piezoelectric layer between the first electrode layer and the second electrode layer, wherein the piezoelectric layer transmits a first ultrasonic acoustic signal based on a first electrical signal between the first electrode layer and the second electrode layer, and outputs a second electrical signal to the first electrode layer and the second electrode layer based on a second ultrasonic acoustic signal received by the piezoelectric layer. The PMUT further comprises a plurality of vent holes that extend through the membrane, wherein a quantity of the plurality of vent holes, a location of each of the plurality of vent holes, and an area of each of the plurality of vent holes is selected to balance robustness to the applied pressure and a desired ultrasonic acoustic performance.

In an embodiment of the present disclosure, a method for designing a piezoelectric micromachined ultrasonic transducer (PMUT) robust to an applied pressure comprises defining a structure of a membrane for transmitting an ultrasonic acoustic signal having a desired ultrasonic acoustic signal strength, determining, for the desired ultrasonic acoustic signal strength, a plurality of initial vent hole configurations, wherein each initial vent hole configuration comprises a number of vent holes and an area of each of the vent holes, determining, for each initial vent hole configuration, an applied pressure robustness, and determining, for each of the initial vent hole configuration, an ultrasonic acoustic performance value, wherein each ultrasonic acoustic performance value is based on a respective distance of the vent holes of a respective initial vent hole configuration from a predetermined location within the membrane. The method further comprises selecting, from the initial vent hole configurations, a final vent hole configuration based on the respective robustness to applied pressure and the respective ultrasonic acoustic performance values, wherein the final vent hole configuration includes a final number of the vent holes and a final area of the vent holes selected from one of the initial vent hole configurations and a final distance from the predetermined location based on one of the respective distances.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative PMUT system in accordance with an embodiment of the present disclosure;

FIG. 2 depicts an exemplary PMUT with a single central vent hole;

FIG. 3 depicts an exemplary plot of transmission factors for a variety of PMUT vent hole diameters of a single vent hole;

FIG. 4 depicts an exemplary PMUT with angularly distributed vent holes in a first configuration in accordance with an embodiment of the present disclosure;

FIG. 5 depicts an exemplary PMUT with angularly distributed vent holes in a second configuration in accordance with an embodiment of the present disclosure;

FIG. 6A depicts a plot of vent hole number versus vent hole diameter to achieve a first particular transmission factor in accordance with an embodiment of the present disclosure;

FIG. 6B depicts a plot of vent hole number versus vent hole diameter to achieve a second particular transmission factor in accordance with an embodiment of the present disclosure;

FIG. 7 depicts a table corresponding to vent hole number and diameter options for particular transmission factors in accordance with an embodiment of the present disclosure;

FIG. 8 depicts plots of pressure dissipation responses to applied pressure burst profiles for different options for vent hole configurations in accordance with an embodiment of the present disclosure;

FIG. 9 depicts plots of the ultrasonic acoustic power output from a PMUT with particular vent hole configurations in accordance with an embodiment of the present disclosure;

FIG. 10 depicts an exemplary PMUT with rectangular membrane and inactive regions having distributed vent holes in accordance with an embodiment of the present disclosure; and

FIG. 11 depicts exemplary steps for designing a PMUT having a plurality of vent holes in accordance with an embodiment of the present disclosure.

### DETAILED DESCRIPTION

Piezoelectric micromachined ultrasound transducers (PMUTs) typically have a membrane-type structure that can break when subject to significant external pressure waves such as those that can be generated by dropping an enclosure face down or exposure to a challenging external environment. Robustness to the external pressure is typically tested, for example, through the use of a compressed air test (CAT) and consumer device manufacturers that integrate PMUT sometimes have requirements that need to be met.

An exemplary PMUT robust to external pressure bursts has non-centered vent holes with a diameter, number, and positioning for improving applied pressure burst response while maintaining ultrasonic acoustic performance of membranes used for ultrasonic transducers. Rather than having a single vent hole centered within the PMUT, multiple vent holes are located at a variety of locations within the PMUT membrane in a manner that achieves increased robustness to applied pressure bursts. The relative ultrasonic acoustic performance of a given number, vent diameter, and configuration of vent holes is generally an inverse function of the transmission factor (“TF”), which corresponds to the ultrasonic acoustic power transferred through the vent holes. For vent hole configurations with equal transmission factors, applied pressure burst response and ultrasonic acoustic performance can be improved by changing the characteristics of the vent holes.

Vent hole locations and number of vent holes can be optimized to properly balance applied pressure burst performance and ultrasonic acoustic performance, for example, by selecting where the vent holes will be located (e.g., active regions, inactive regions, inactive regions with layers removed, and combinations thereof), vent hole size (e.g., diameter), vent hole shape (e.g., circular), and the like, to identify a variety of possible options of vent hole configurations. For example, distributing multiple vent holes within inactive regions of the PMUT prevents loss of effective piezoelectric area, thus improving ultrasonic acoustic performance relative to designs that include vent holes in active regions such as the center of the PMUT. Those options may then be analyzed versus ultrasonic acoustic performance criteria and applied pressure burst performance criteria to select a vent hole configuration for the particular device.

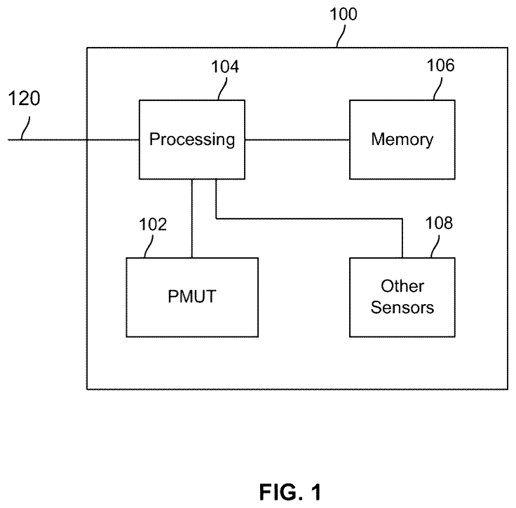

FIG. 1 shows an illustrative PMUT system 100 in accordance with an embodiment of the present disclosure. Although particular components are depicted in FIG. 1, it will be understood that other suitable combinations of the PMUTs, other sensors (e.g., microelectromechanical system (“MEMS”) or PMUT sensors) processing components, memory, and other circuitry may be utilized as necessary for different applications and systems. In accordance with the present disclosure, the PMUT system may include a PMUT sensor 102 as well as additional sensors 108. Although the present disclosure will be described in the context of signals received from certain PMUT sensor designs and configurations, it will be understood that the utilization of vent holes to obtain robustness to external events such as pressure bursts while maintaining desired ultrasonic acoustic performance characteristics of the present disclosure may be utilized with any suitable PMUT design, including a variety different membrane materials, membrane layers, membrane shapes, fabrication techniques, and combinations thereof.

Processing circuitry 104 may include one or more components providing processing based on the requirements of the PMUT system 100. In some embodiments, processing circuitry 104 may include hardware control logic that may be integrated within a chip of a sensor (e.g., of a die of a PMUT sensor 102 or other sensors 108, or on an adjacent portion of a chip to the PMUT sensor 102 or other sensors 108) to control the operation of the PMUT sensor 102 or other sensors 108 and perform aspects of processing for the PMUT sensor 102 or the other sensors 108. In some embodiments, the PMUT sensor 102 and other sensors 108 may include one or more registers that allow aspects of the operation of hardware control logic to be modified (e.g., by modifying a value of a register). In some embodiments, processing circuitry 104 may also include a processor such as a microprocessor that executes software instructions, e.g., that are stored in memory 106. The microprocessor may control the operation of the PMUT sensor 102 by interacting with the hardware control logic and processing signals received from PMUT sensor 102. The microprocessor may interact with other sensors 108 in a similar manner. In some embodiments, some or all of the functions of the processing circuitry 104, and in some embodiments, of memory 106, may be implemented on an application specific integrated circuit (“ASIC”) and/or a field programmable gate array (“FPGA”).

Although in some embodiments (not depicted in FIG. 1), the PMUT sensor 102 or other sensors 108 may communicate directly with external circuitry (e.g., via a serial bus or direct connection to sensor outputs and control inputs), in an embodiment the processing circuitry 104 may process data received from the PMUT sensor 102 and other sensors 108 and communicate with external components via a communication interface 110 (e.g., a serial peripheral interface (SPI) or I2C bus, in automotive applications a controller area network (CAN) or Local Interconnect Network (LIN) bus, or in other applications a suitably wired or wireless communications interface as is known in the art). The processing circuitry 104 may convert signals received from the PMUT sensor 102 and other sensors 108 into appropriate measurement units (e.g., based on settings provided by other computing units communicating over the communication interface 110).

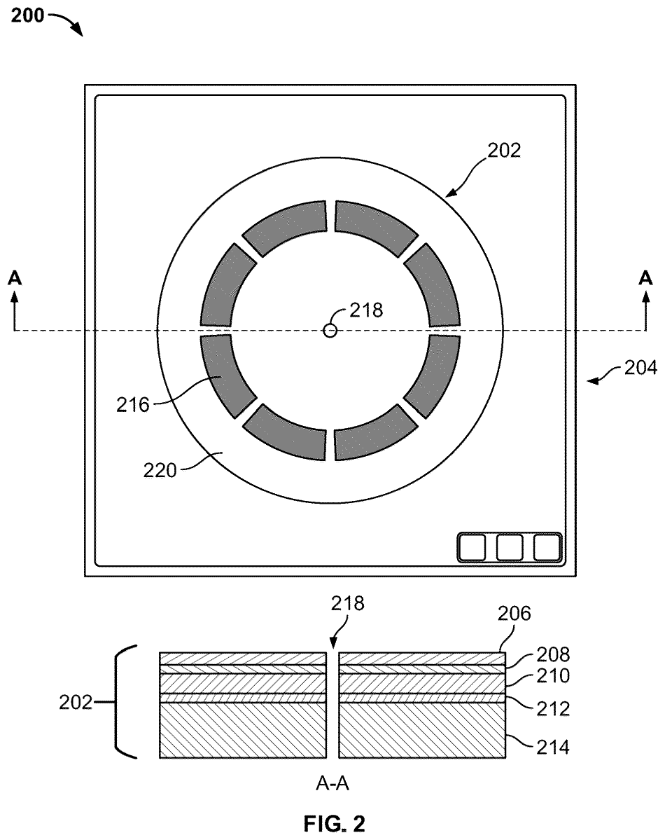

FIG. 2 depicts an exemplary PMUT device 200 with a central vent hole. In the context of the present disclosure, PMUT structures will be depicted and described in simplified format, for example, with the PMUT device 200 having a membrane 202 located on a PMUT die 204, with the membrane 202 including a piezoelectric layer 210 located between an upper electrode layer 208 and a lower electrode layer 212, an upper structural layer 206 located above the upper electrode layer (e.g., in the direction of transmission/reception), and a lower structural layer 214 located below and providing support for the other layers of the PMUT device. The membrane 202 includes active regions 220 and inactive regions 216. Exemplary active regions are regions that actively participate in the transmission and reception of ultrasonic acoustic signals, e.g., based on the electrical and mechanical configuration of the piezoelectric and electrode layers (e.g., with piezoelectric layer 210 located between electrode layers 208 and 212). Although inactive regions such as inactive region 216 (e.g., including all of the gray portions of the top view in FIG. 2) may be depicted in particular locations and configurations and with particular sizes in the present disclosure, it will be understood that the respective location, configuration, and size of inactive region will be determined based on the particular underlying PMUT design. A particular membrane design may, for example, have a particular resonance frequency, and alternative designs may have different resonance frequencies.

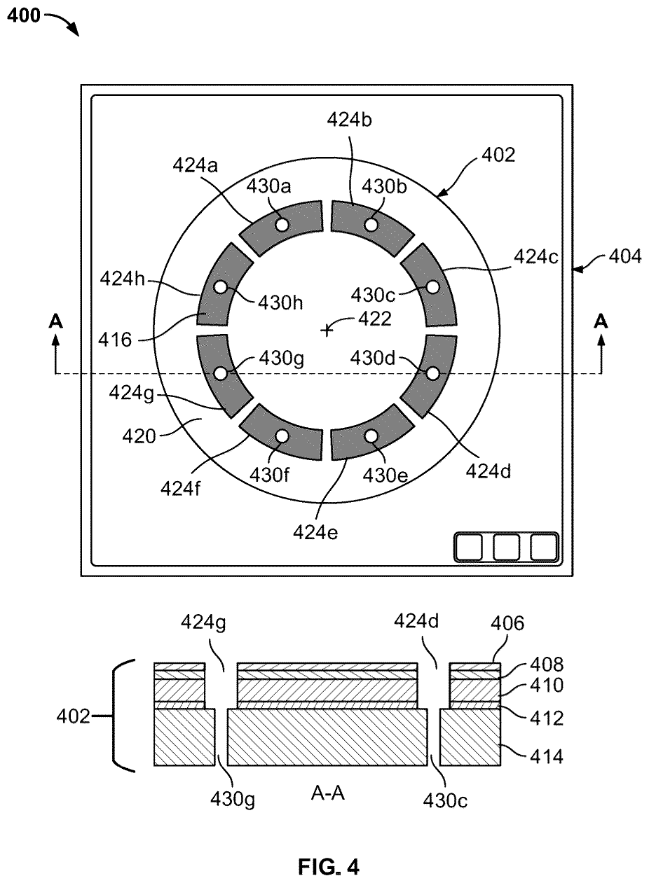

In the embodiments depicted herein, inactive regions may be inactive because certain layers are removed, such as the upper structural layer 206, upper electrode layer 208, piezoelectric layer 210, and lower electrode layer 212 (material removal not depicted in FIG. 2 based on location of section line A-A, but depicted in FIGS. 4, 5, and 10), referred to herein as removed regions. A removed region as referred to herein refers to any region in which one or more layers of the PMUT membrane is removed in accordance with the PMUT design. It will also be understood that inactive regions may be inactive based on other aspects of the PMUT design other than material removal, such as inactivating electrodes within certain portions of the PMUT membrane. Examples of PMUT membranes having inactive regions that are not removed regions are depicted and described in U.S. patent application Ser. No. 18/403,964, filed Jan. 4, 2024, and entitled “PMUT with Partially Inactive Piezoelectric,” which is incorporated by reference herein in its entirety for all purposes. Although some of the vent holes described herein may be located in inactive regions that are removed regions (e.g., with the vent hole required to extend only through some layers of the membrane), vent holes may also be located within active regions or inactive regions that are not removed regions, and combinations thereof (including with some vent holes in removed regions). Locating vent holes within inactive regions (e.g., whether removed or not removed inactive regions) limits the impact of the vent holes on the ultrasonic acoustic performance of a PMUT design, and increases overall ultrasonic acoustic performance and transmit power compared with designs where the vent holes are located in otherwise active regions.

Intervening layers, bonding layers, electrical connections, and vias are not depicted but will be understood to be encompassed within the present disclosure. The particular locations, shapes, configurations, and other characteristics depicted are exemplary only, and it will be understood that the present disclosure may be applied to any suitable PMUT devices and membranes capable of having vent holes. Moreover, PMUT devices and membranes in accordance with the present disclosure may be configured in an end-use product (e.g., on one or more dies, in an array, etc.) as suitable for particular applications. Structural depictions of PMUT devices and membranes depicted herein (e.g., including in FIGS. 2, 4, 5, and 10) should be similarly understood to include all suitable PMUT devices, PMUT membranes, and vent hole configurations.

End-use applications for PMUT devices such as a PMUT device 200 often transmit ultrasonic acoustic signals into and receive ultrasonic acoustic reflections from an environment (e.g., a region of interest) external to the end-use device including the PMUT device. This external environment may expose the PMUT membrane 202 to external forces such as pressure bursts, which in turn may depend on the location and mounting of the PMUT membrane 202 (e.g., fully or partially exposed to the external environment, protected by a passage, through-hole, or mesh, etc.), the end-use application (e.g., in a fixed location, on a wearable device, on a vehicle, drone, etc.), and the end-use environment (e.g., indoor environment, outdoor environment, industrial environment, etc.). Accordingly, some PMUT devices utilize a vent hole such as vent hole 218, which is typically centrally located within the PMUT membrane 202 and extending through all layers of the PMUT membrane 202, as depicted in Section A-A of FIG. 2. Rather than impacting the entirety of the PMUT membrane 202, some of the energy from a pressure burst passes through the vent hole 218 and partially equalizes on the opposite side of the PMUT membrane 202, facilitating the dissipation of the pressure burst experienced by the membrane. However, such simplistic vent hole designs may not adequately dissipate the applied pressure burst from the membrane in some environments or applications. Further, locating the vent hole at an arbitrary location such as centrally may negatively impact ultrasonic acoustic performance, such as by changing a mode shape of the PMUT membrane 202 or decreasing the transmitted ultrasonic acoustic power by reducing the active area of piezoelectric transduction. Attempted modifications to increase robustness to applied pressure burst such as increasing the diameter of the vent hole may lead to further reductions in ultrasonic acoustic performance, resulting in designs that cannot provide both the necessary applied pressure burst dissipation and ultrasonic acoustic performance.

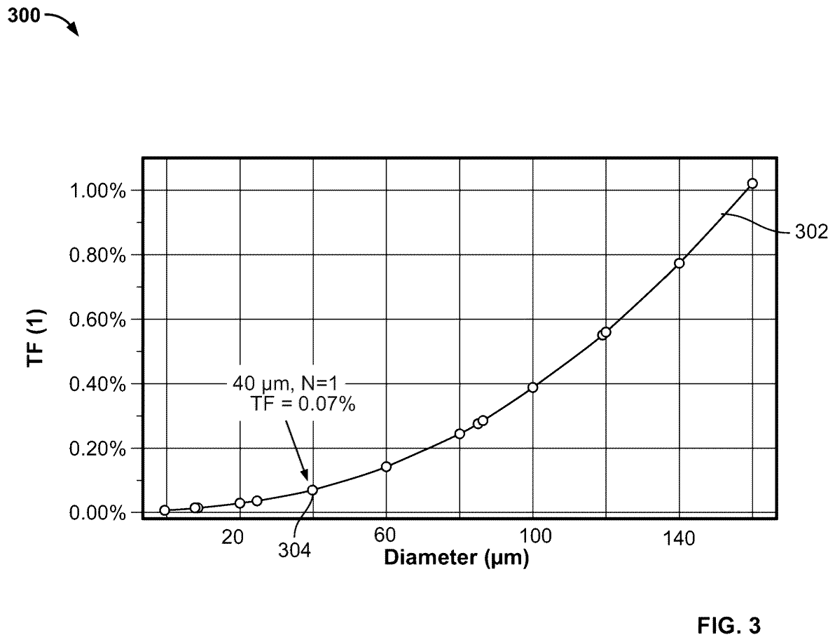

FIG. 3 depicts an exemplary plot 300 of transmission factors for a single PMUT vent hole with a variety of vent hole diameters. One manner of increasing the robustness of a PMUT device such as that depicted in FIG. 2 to applied pressure burst may be to increase the diameter of the vent hole, since a larger vent hole will provide a larger passage for dissipation of the pressure as well as potential equalization. As depicted in FIG. 3, a plot of transmission factor (“TF”) versus vent hole diameter at a particular frequency for a single vent hole is depicted by plot line 302. The abscissa of FIG. 3 corresponds to the vent hole diameter in micrometers while the ordinate of FIG. 3 corresponds to the transmission factor for the particular vent hole. Plot line 302 connects between points (circles) showing a measured or simulated transmission factor for particular vent hole diameters for a particular PMUT membrane design (e.g., circular, with annular inactive regions) including a single vent hole of varying diameter.

The transmission factor quantifies ultrasonic acoustic power transmission through the vent hole at specific frequencies and is determined in accordance with a single-vent simulation in the embodiment depicted in FIG. 3. Although transmission factor is not equivalent to a particular ultrasonic acoustic performance, as a general matter a greater transmission factor may correspond to lower ultrasonic acoustic performance. For example, an increased diameter of a centrally located vent hole may negatively affect the overall ultrasonic acoustic power output of the PMUT membrane during transmission, or the received signal amplitude during reception.

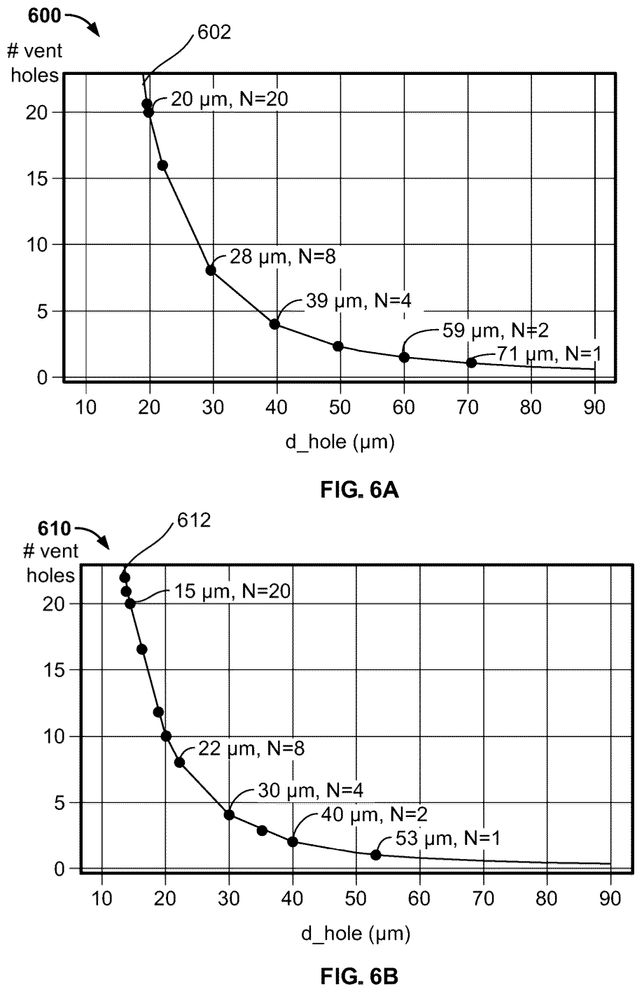

As is depicted in FIG. 3, transmission factor tends to increase nonlinearly with an increase in vent hole diameter. For example, in the exemplary plot of FIG. 3, a 20 μm vent hole will have a transmission factor of approximately 0.03%, a 40 μm vent hole will have a transmission factor of approximately 0.07%, a 60 μm vent hole will have a transmission factor of approximately 0.16%, and a 100 μm vent hole will have a transmission factor of approximately 0.39%. As will be described further herein (e.g., with respect to FIGS. 6A-6B), adding additional vent holes also increases transmission factor. By selectively adding vent holes at different locations, a desired transmission factor (e.g., corresponding to burst robustness) can be achieved with multiple different combinations of vent hole locations, sizes, shapes, and other characteristics.

FIG. 4 depicts an exemplary PMUT with angularly distributed vent holes in a first configuration in accordance with an embodiment of the present disclosure. In accordance with the present disclosure, the number, location, size, and shape of vent holes can be selected in a manner that optimizes both robustness to applied pressure bursts and ultrasonic acoustic performance. For purposes of illustration, vent holes depicted in FIGS. 4, 5, and 10 are circular or rectangular in shape and are depicted with particular proportions. It will be understood that vent holes may have other shapes (e.g., oval, slits, square, rectangular, polygon, irregular, etc.) based on factors such as resulting ultrasonic acoustic performance (e.g., changes in modeshape or TF caused by vent hole particular shapes), dissipation of applied pressure bursts, structural integrity of the PMUT, and fabrication techniques. As described herein, the location (e.g., radial location) of vent holes and vent hole size (e.g., diameter) may be selected to optimize and balance robustness to pressure bursts (e.g., pressure dissipation) and ultrasonic acoustic performance. Although the plurality of vent holes of FIGS. 4, 5, and 10 will each be described as being at common radial and/or linear distances (e.g., from a center point of the PMUT membrane) within inactive regions that are removed regions, and having common sizes (e.g., diameters), it will be understood that vent holes may be located at multiple different distances (e.g., radial or linear distances) within a single PMUT membrane, may have multiple sizes (e.g., diameters) within a single PMUT membrane, and may be located within a variety of types of PMUT membrane regions (e.g., active regions, inactive regions, inactive regions that are removed regions, and combinations thereof), as is suitable for a particular PMUT membrane design in accordance with the present disclosure.

In the embodiment of FIG. 4, the basic design of the PMUT device 400 corresponds to the PMUT device 200 of FIG. 2, for example, with PMUT device 400 having a membrane 402 located on a PMUT die 404, with the membrane 402 including a piezoelectric layer 410 located between an upper electrode layer 408 and a lower electrode layer 412, an upper structural layer 406 located above the upper electrode layer (e.g., in the direction of transmission/reception), and a lower structural layer 414 located below and providing support for the other layers of the PMUT device. The membrane 402 includes active regions 420 and inactive regions 416 (e.g., gray regions as shown in the top view). As depicted in FIG. 4, each of the inactive regions 416 is a respective removed region 424a-424h, with a respective vent hole 430a-430h located therein (e.g., through the unremoved lower structural layer 414 located below the removed regions). In the embodiment of FIG. 4, each of the vent holes 430a-430h is centered at common radial location Rᵥₕ relative to the center point 422 of the circular membrane 402 and has a common diameter Dᵥₕ. The removed regions 424a-424h have all layers except the lower structural layer 414 removed (e.g., upper structural layer 406, upper electrode layer 408, piezoelectric layer 410, lower electrode layer 412) in an annular ring pattern having an inner radius Rᵢₙₙₑᵣ and an outer radius Rₒᵤₜₑᵣ.

As is depicted in the section view A-A of FIG. 4 (only membrane 402 depicted) through removed regions 424d and 424g, the vent holes 430d and 430g are approximately centered within the removed regions and have a diameter that is less than the distance between Rᵢₙₙₑᵣ and Rₒᵤₜₑᵣ. Each of vent holes 430a-430c, 430e-430f, and 430h is similarly centered within a respective removed region 424a-424c, 424e-424f, and 424h. Placing vent holes within inactive regions (e.g., including, but not limited to removed regions) may minimize negative effects of vent holes on PMUT ultrasonic acoustic performance, for example, by placing the vent holes where PMUT ultrasonic acoustic performance is already lower (e.g., for inactive regions) or where the modeshape is less impacted due to fewer layers having material removed due to the vent hole (e.g., for inactive regions that are removed regions). Having multiple vent holes at multiple locations may improve robustness to applied pressure bursts by distributing both the vertical dissipation through the membrane 402 as well as pressure equalization on the opposite side of membrane 402 (e.g., on the opposite surface of lower structural layer 414). As described herein, the number, locations, and size of the vent holes can be optimized to achieve desired robustness to applied pressure bursts and ultrasonic acoustic performance for particular PMUT designs and/or applications.

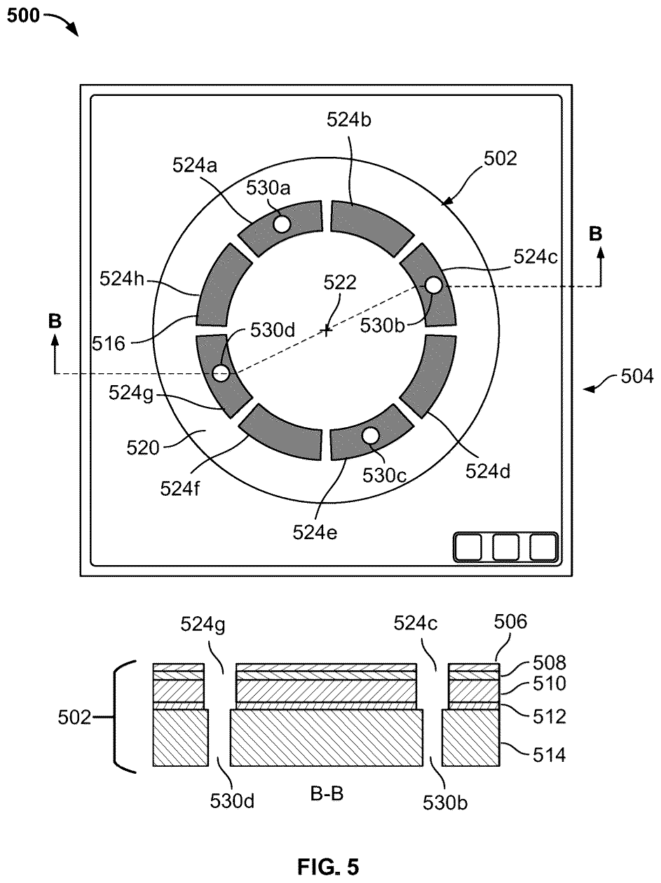

FIG. 5 depicts an exemplary PMUT with angularly distributed vent holes in a second configuration in accordance with an embodiment of the present disclosure. Similar components from FIG. 4 and FIG. 5, are numbered similarly, including PMUT device 400 and PMUT device 500, membrane 402 and membrane 502, PMUT die 404 and PMUT die 504, upper structural layer 406 and upper structural layer 506, upper electrode layer 408 and upper electrode layer 508, piezoelectric layer 410 and piezoelectric layer 510, lower electrode layer 412 and lower electrode layer 512, lower structural layer 414 and lower structural region 514, inactive regions 416 (e.g., gray regions as shown in the top view) and inactive regions 516, active regions 420 and active regions 520, center point 422 and center point 522, and respective removed regions 424a-424h of the inactive regions 416 and respective removed regions 524a-524h of the inactive regions 516. A cross section B-B is shown below the top view in FIG. 5. In contrast with the embodiment depicted in FIG. 4, the embodiment of FIG. 5 only has four vent hole 530a-530d holes rather than eight vent holes 430a-430h, with vent hole 530a located within removed region 524a, vent hole 530b located within removed region 524c, vent hole 530c located within removed region 524e, and vent hole 530d located within removed region 524g. The vent holes 530a-530d are distributed at 90 degrees from each other about a common radius Rᵥₕ from center point 522 and have a common diameter Dᵥₕ. In the embodiments depicted in FIGS. 4 and 5, the diameter Dᵥₕ of each of the vent holes 530a-530d is greater than the diameter Dᵥₕ of each of the vent holes 430a-430g.

FIG. 5 provides merely one example of an alternative vent hole configurations for a single membrane 402/502 design. As other examples merely of evenly distributed vent holes, 16 vent holes could be evenly distributed at 22.5 degrees with respect to each other, with two vent holes located within each removed region 524a-524g, or 32 holes could be distributed with four vent holes located within each removed region 524a-524g. Vent holes may also be “stacked” at different radial distances R_{VH} with respect to center point 522, for example, with multiple vent holes located at a common angular locations within each removed region 524a-524g. And as noted above, other configurations may include other distributions, including within active regions or inactive regions that are not removed regions, non-regular (e.g., not evenly distributed) locations, and with a variety of shapes and sizes. However, merely utilizing regularly spaced circular vent holes located within removed regions as examples, it can be seen how multiple numbers (e.g., 2, 4, 8, 16, 32, etc.) and diameters of vent holes may be utilized for optimization of robustness to applied pressure bursts and ultrasonic acoustic performance.

FIG. 6A depicts a plot 600 of vent hole number versus vent hole diameter to achieve a first particular transmission factor in accordance with an embodiment of the present disclosure, while FIG. 6B depicts a plot 610 of vent hole number versus vent hole diameter to achieve a second particular transmission factor in accordance with an embodiment of the present disclosure. Transmission factor can be used as an initial design criteria or goal, for example, to achieve a desired power transfer through vent hole configurations, which in turn, roughly relates to ultrasonic acoustic performance (e.g., increasing ultrasonic acoustic performance with lower transmission factor for a particular vent hole configuration) and also affects robustness to an applied pressure burst (e.g., increasing robustness with increasing transmission factor for a particular vent hole configuration). In practice, the burst robustness and ultrasonic acoustic performance will be design-specific, including based on which regions of a structure the vent holes are located at (e.g., active regions, inactive regions, removed regions, or combinations thereof), distance of the vent holes from center or edge points of the membrane, vent hole diameter, vent hole shape (e.g., if not circular), membrane anchoring locations, and the like.

As depicted in each of FIGS. 6A and 6B, a plot of number of holes vs hole diameter for a particular transmission factor is depicted by plot line 602 in FIG. 6A and corresponding to a first transmission factor and by plot line 612 in FIG. 6B corresponding to a second transmission factor. The abscissae of FIGS. 6A and 6B correspond to the vent hole diameter in micrometers while the ordinates of FIGS. 6A and 6B correspond to a number of vent holes. Plot line 602 of FIG. 6A thus includes a plot line fitted to points for selected numbers of vent holes from 1 to 21 and corresponding vent hole diameters from 19 μm (for 21 vent holes) to 71 μm (for one vent hole) to achieve a first transmission factor. Plot line 612 of FIG. 6B in turn includes a plot line fitted to points for selected numbers of vent holes from 1 to 22 and corresponding vent hole diameters from 13 μm (for 22 vent holes) to 53 μm (for one vent hole) to achieve a second (lower) transmission factor. These plots may be generated in a variety of suitable manners, including by fabricating test components having various alternative designs, utilizing specialized test membranes (e.g., with adjustable vent hole diameters and openings), or suitable simulations. In the examples depicted in FIGS. 6A and 6B, it is assumed that whatever the number of vent holes, the vent holes are evenly distributed about the membrane at a common relative location or region within the membrane, for example, within an annular ring region at a particular radius relative to a center point of a circular membrane.

Plots 602 and 612 of FIGS. 6A and 6B demonstrate that there are a variety of options for number and diameter of vent holes to achieve a particular transmission factor. Although transmission factor does not directly dictate either robustness to applied pressure bursts or to ultrasonic acoustic performance, design alternatives having a similar transmission factor may be used as one criterion for selecting a plurality of initial vent hole configurations. For example, if each of the first transmission factor of FIG. 6A and the second transmission factor of FIG. 6B fall within initial bounds likely to result in acceptable configurations, design options such as those depicted as the points of plots 602 and 612 may be used as initial vent hole configurations for further analysis and testing. In addition, other options may be extrapolated from the plots 602 and 612 or from the underlying data, including non-depicted options that fall on plots 602 or 612, or estimates for other transmission factors with the same design.

The plots depicted in FIGS. 6A and 6B are merely exemplary of potential methodologies for selecting initial vent hole configurations for a membrane design. For example, an initial membrane design may have a particular shape, layers, layer thicknesses, anchoring points, inactive regions, removed regions, operating frequency, and the like. Application-based performance targets are also considered. For example, some applications will place a higher importance on acoustic performance, in which case a lower TF would be targeted in the initial design configuration. Other applications can place a high importance on robustness, in which case a higher TF would be targeted in the initial design to improve pressure equalization. Once these general parameters for the membrane structure are defined, initial vent hole configurations may be selected as described in FIGS. 6A and 6B (e.g., based on testing and/or simulations), or in some embodiments, may be selected based on the membrane design, for example, the locations of removed regions or inactive regions, the locations of anchoring points, the operating frequency, and the like.

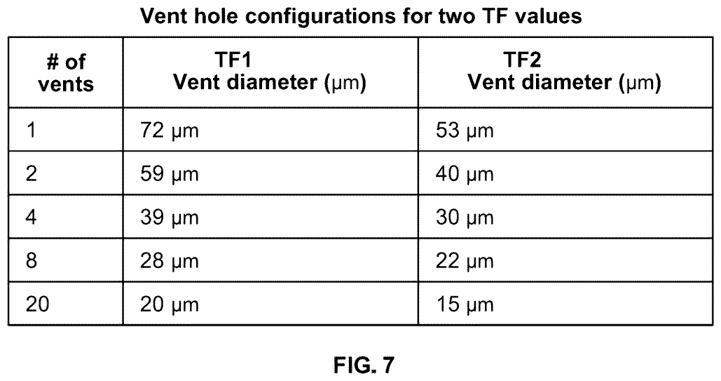

FIG. 7 depicts a table corresponding to vent hole number and diameter options for particular transmission factors for an exemplary membrane operating under certain conditions (e.g., operating frequency) in accordance with an embodiment of the present disclosure. As discussed herein, in some embodiments transmission factor may be used as an initial constraint to identify a plurality of initial vent hole configurations for further testing or analysis. An example is depicted in FIG. 7, in which particular vent hole configurations (e.g., number and diameter of vent holes) corresponding to points on plots 602 and 612 for respective transmission factors TF1 and TF2 are identified. The depicted initial vent hole configurations are exemplary only, and it will be understood that in the context of FIGS. 6A and 6B, other options of vent hole number versus size may be selected. Further, other options (not depicted) may be further selected for initial vent hole configurations by calculating or estimating vent hole number and size for intermediate, higher, or lower transmission factors, which may be determined based on interpolation, extrapolation, best fit, or other similar techniques based on known values for transmission factors of TF1 and TF2. For the exemplary TF1 and TF2 values depicted and described herein, TF1 corresponds to a higher transmission factor than TF2.

In some embodiments, initial constraints may be utilized for determination of initial vent hole configurations as an alternative to or in addition to transmission factor. As one example, an example or similar design to the particular membrane type under test may have known robustness to applied pressure bursts and/or ultrasonic acoustic performance properties. One or more predetermined numbers of vent holes (e.g., 4, 8, 16, etc,) may be selected and multiple diameter values (e.g., 2-4 test values) may be selected for each predetermined number of vent holes, based on a desired change in applied pressure burst dissipation and ultrasonic acoustic properties. The options may be selected based on the desired change versus the example or similar design, for example, if an increase in burst robustness is needed the number of vent holes may be increased from the example or similar design, with a variety of options of vent hole diameter. As another example, if the example or similar design has ample robustness to applied pressure bursts and an increase in ultrasonic acoustic performance is required, vent hole diameters may be decreased and various options of numbers of vent holes may selected as initial vent hole configurations.

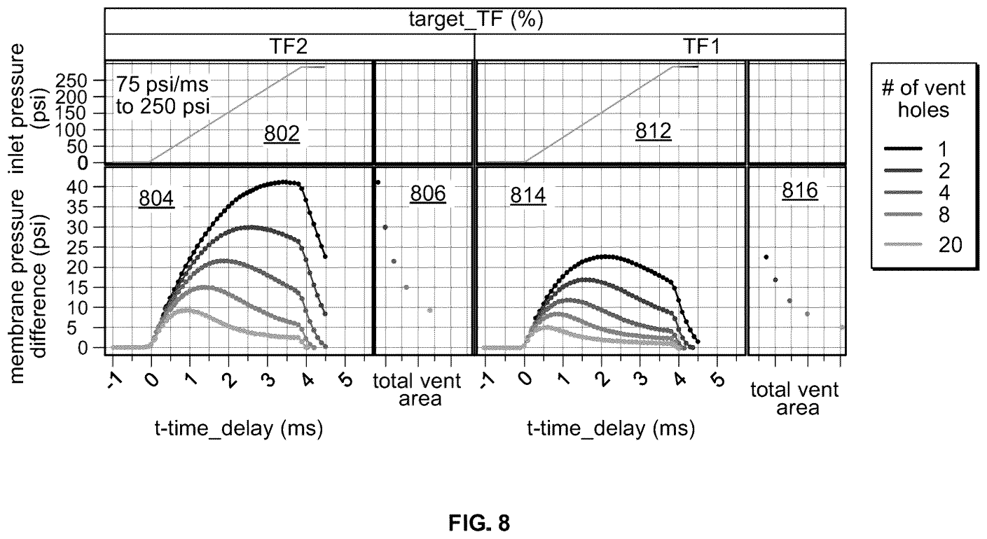

FIG. 8 depicts plots of pressure dissipation responses to applied pressure burst profiles for different options for vent hole configurations in accordance with an embodiment of the present disclosure. As depicted in FIG. 8, on the left side there are three plots 802, 804, and 806 associated with five different initial vent hole configurations (e.g., each with other similar design parameters, including back cavity volume (e.g., the enclosed air volume or package acoustic volume in a PMUT package) for the second transmission factor TF2 including one vent hole (darkest points and lines), two vent holes (second darkest points and lines), four vent holes (third darkest points and lines), eight vent holes (second lightest points and lines), and 20 vent holes (lightest points and lines). On the right side there are three plots 812, 814, and 816 associated with five different initial vent hole configurations for the transmission factor TF1 including one vent hole (darkest points and lines), two vent holes (second darkest points and lines), four vent holes (third darkest points and lines), eight vent holes (second lightest points and lines), and 20 vent holes (lightest points and lines).

The plots 802 and 812 each share an abscissa with a corresponding plot 804 or 814 (below 802 and 812, respectively), with the abscissa corresponding to a time scale in milliseconds and the ordinates of plots 802 and 812 corresponding to a pressure profile applied to each vent hole configuration for testing purposes (e.g., on production or prototype components, and/or simulations). In each of plots 802 and 812, the pressure is increased by 75 psi per millisecond, up to a maximum pressure of 275 psi at 3.75 milliseconds. This ramp pattern is provided merely as an example, and other pressure values, ramp rates, and patterns may be utilized in accordance with expected pressure burst conditions for end-use applications. For example, regular or irregular pressure bursts may be utilized to test rate of pressure dissipation, or significant pressure may be interspersed with vacuum or near vacuum conditions.

Located below the plots 802 and 812, on a common timescale, are plots 804 and 814 of the corresponding pressure differential between sides of the membrane for each initial vent hole configuration, with the ordinate being in units of psi. This pressure differential corresponds to the force that is likely to cause damage to the membrane in a pressure burst condition. For the example of TF2 vent hole configurations, the plot 804 shows a ramping up to approximately 41 psi for the single vent hole configuration, and approximately 9.5 psi for the 20 vent hole initial configuration. Each of the configurations including multiple vent holes reaches a maximum pressure difference after an initial ramp period (e.g., approximately one millisecond for the 20 vent hole configuration, and approximately 2.5 milliseconds for the 2 vent hole configuration), with the pressure differential quickly dissipating once the pressure reaches a steady state. For the example of TF1 vent hole configurations, the plot 814 shows a ramping up to approximately 23 psi for the single vent hole configuration, and approximately 5 psi for the 20 vent hole initial configuration. Each of the configurations reaches a maximum pressure difference after an initial ramp period (e.g., approximately 0.7 milliseconds for the 20 vent hole configuration, and approximately 2.3 milliseconds for the single vent hole configuration), with the pressure differential quickly dissipating once the pressure reaches a steady state. As can be seen from the plots 804 corresponding to TF2 and 814 corresponding to TF1, the TF1 configurations corresponding to a higher transmission factor than TF2 better dissipate the applied pressure compared to the TF2 configurations.

The plots 806 and 816 show normalized vent hole area versus maximum pressure differential for each of the initial vent hole configurations. As can be seen from each of the plots, one of the factors influencing the greater dissipation for multiple vent hole designs is a greater total vent hole area for such designs. As described herein, to the extent that multiple vent hole designs with comparable TF do not substantially decrease ultrasonic acoustic performance, such designs may provide superior robustness to applied pressure bursts, particularly when compared to single vent hole designs.

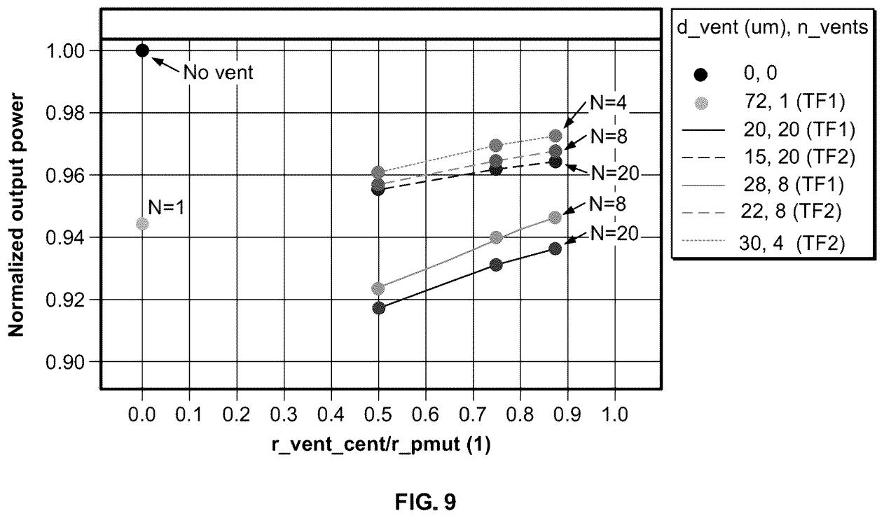

FIG. 9 depicts plots of ultrasonic acoustic power output for an example PMUT with particular vent hole configurations in accordance with an embodiment of the present disclosure. As depicted in FIG. 9, seven initial different initial vent hole configurations are plotted, including three configurations corresponding to the first transmission factor TF1 (e.g., the one vent hole, eight vent hole, and 20 vent hole initial configurations), three corresponding to the TF2 vent hole configurations (e.g., four vent hole, eight vent hole, and 20 vent hole initial configurations), and one corresponding to no vent holes. This subset of initial vent hole configurations may be selected to demonstrate the baseline ultrasonic acoustic performance with no vent holes for comparison with vent hole designs that appear to have suitable robustness to applied pressure bursts (e.g., selected based on analysis such as that depicted in FIG. 8). The abscissa of FIG. 9 is in normalized radius from the center of the PMUT membrane, to allow for depiction of different options for locations of vent holes, while the ordinate is in units of normalized output power, which in turn corresponds to ultrasonic acoustic performance.

As is depicted in FIG. 9, a design with no vent holes and a single vent hole design are each depicted at location zero (e.g., the PMUT center), with a no vent hole design having a normalized output power of one setting the baseline ultrasonic acoustic performance. The single centered vent hole design results in an overall reduction of ultrasonic acoustic performance of over 5%, and with cross reference to plot 814 of FIG. 8, is also less robust to applied pressure bursts as compared to any of the multi-vent hole designs depicted in FIG. 9.

As is depicted for each of the multi-vent hole designs of FIG. 9, for illustration purposes, each design is tested (e.g., based on production or prototype components, a dedicated test component, and/or simulations) with the vent holes evenly distributed as centered at three different radii, for example, at 50% of the overall membrane radius, 75% of the overall membrane radius, and 88% of the overall membrane radius. As described herein, the membrane may include a variety of shapes and configurations, as may the vent holes, and even distribution is not required. As is depicted in FIG. 9, as a general matter moving the vent holes away from the center point of the membrane tends to increase ultrasonic acoustic performance, but may provide different impacts in different designs (e.g., having different vibration modeshapes), for example, where a location further from the PMUT center is in an active region of the PMUT rather than an inactive region or removed inactive region. In the depiction of FIG. 9, each vent hole location is assumed to correspond to a removed inactive region.

As can be seen in FIG. 9, the vent hole designs corresponding to the lower transmission factor (e.g., TF2) have a higher ultrasonic acoustic performance than the vent hole designs corresponding to the higher transmission factor (e.g., TF1), while the ultrasonic acoustic performance of the higher transmission factor designs (e.g., 8 and 20 vent holes, depicted as solid lines in FIG. 9) increases substantially as the radial locations moves outward on the membrane.

By utilizing results such as those depicted in FIGS. 8 and 9, a PMUT can be designed utilizing multiple vent holes located, shaped, and sized in accordance with particular design goals and end-use applications, providing a proper balance between robustness to applied pressure bursts and ultrasonic acoustic performance. For example, some end-use applications may require high levels of ultrasonic acoustic sensitivity in relatively controlled environments, in which case a four vent hole design with exterior placement on the membrane may be selected. In end uses that contemplate harsh or unpredictable design environments, a 20 vent hole design corresponding to TF1 or an 8 vent hole design corresponding to a TF2 may be used.

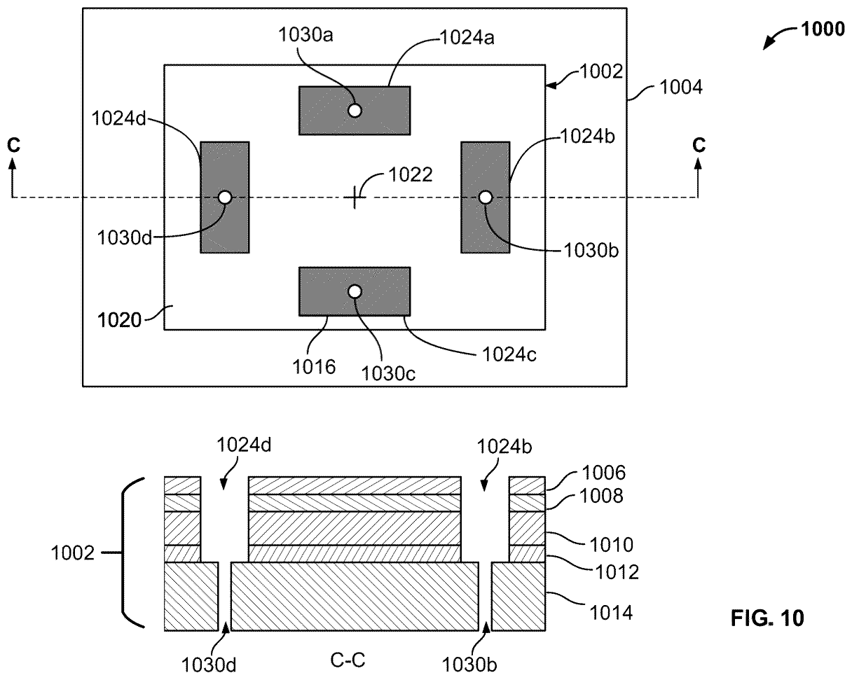

FIG. 10 depicts an exemplary PMUT with a rectangular membrane and inactive regions having distributed vent holes in accordance with an embodiment of the present disclosure. The example provided in FIG. 10 is merely one example of a non-circular PMUT design that includes multiple vent holes at respective locations within the membrane. It will be understood that the present disclosure applies to any suitable PMUT membrane design, including with a variety of membrane shapes, anchoring locations, inactive regions, removed inactive regions, vent hole shapes and sizes, and the like. In the embodiment of FIG. 10, a PMUT device 1000 has a rectangular membrane 1002 located on a PMUT die 1004, with the membrane 1002 including a piezoelectric layer 1010 located between an upper electrode layer 1008 and a lower electrode layer 1012, an upper structural layer 1006 located above the upper electrode layer (e.g., in the direction of transmission/reception), and a lower structural layer 1014 located below and providing support for the other layers of the PMUT device. The membrane 1002 includes active regions 1020 and inactive regions 1016 (e.g., gray regions as shown in the top view). As depicted in FIG. 10, each of the inactive regions 1016 is a respective removed region 1024a-1024d, with a respective vent hole 1030a-1030d located therein (e.g., through the unremoved lower structural layer 1014 located below the removed regions). In the embodiment of FIG. 10, each of the vent holes 1030a-1030d is centered within the inactive region 1024a-1024d and has a common diameter. The removed regions 1024a-1024d have all layers except the lower structural layer 1014 removed (e.g., upper structural layer 1006, upper electrode layer 1008, piezoelectric layer 1010, lower electrode layer 1012) near the external edge of the membrane 1002.

As is depicted in the section view C-C of FIG. 10 (only membrane 1002 depicted) through removed regions 1024b and 1024d, the vent holes 1030b and 1030d are approximately centered within the removed region and have a diameter that is less than the width of the removed regions. Each of vent holes 1030a and 1030c is similarly centered within a respective removed region 1024a or 1024c. Placing vent holes within inactive regions (e.g., including, but not limited to removed regions) may minimize negative effects of vent holes on PMUT ultrasonic acoustic performance, for example, by placing the vent holes where PMUT ultrasonic acoustic performance is already lower (e.g., for inactive regions) or where the modeshape is less impacted due to fewer layers having material removed due to the vent hole (e.g., for inactive regions that are removed regions). Having multiple vent holes at multiple locations may improve robustness to applied pressure bursts by distributing both the vertical dissipation through the membrane 1002 as well as pressure equalization on the opposite side of membrane 1002 (e.g., on the opposite surface of lower structural layer 1014). As described herein, the number, locations, and size of the vent holes can be optimized to achieve desired robustness to applied pressure bursts and ultrasonic acoustic performance for particular PMUT designs and/or applications.

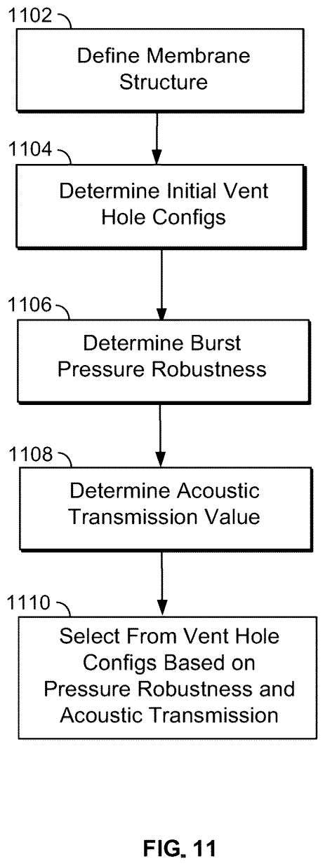

FIG. 11 depicts exemplary steps for designing a PMUT having a plurality of vent holes in accordance with an embodiment of the present disclosure. Although particular steps are depicted in a certain order for FIG. 11, steps may be removed, modified, or substituted, and additional steps may be added in certain embodiments, and in some embodiments, the order of certain steps may be modified.

Processing starts at step 1102, where the membrane structure is defined. The definition of the membrane structure includes a variety of considerations, including membrane shape, membrane layers, layer thickness, internal signal routing, inactive regions, removed inactive regions, and other design elements and considerations to achieve desired design parameters and constraints such as transmit power, receive sensitivity, operating frequency, power consumption, signal-to-noise ratio, and the like. Once the membrane structure has been defined, the design process may continue to step 1104.

At step 1104, initial vent hole configurations are determined. Although initial vent hole configurations may be determined in a variety of manners, considerations may include locations of inactive regions and/or removed inactive regions, manufacturing processes (e.g., to determine available vent hole shapes and sizes), anchoring locations, and modeshape of the membrane. Taking into consideration such initial design constraints, options for vent hole configurations may be selected such as based on one or more transmission factors, with a variety of vent hole designs (e.g., number, shape, size, etc.) being selected as alternatives for each transmission factor. Once the initial vent hole configurations have been determined, the design process may continue to step 1106.

At step 1106, the robustness to applied pressure burst characteristics of the vent hole configurations are determined. For example, prototype or production parts may be tested, and/or simulations may be performed, to determine a pressure differential on the membrane in response to particular pressure patterns. For example, a ramp pattern may be utilized that corresponds to expected pressure burst conditions, such as a linear ramp, although other pressure patterns may be utilized. Once the applied pressure burst dissipation characteristics of the vent hole configurations have been determined, the design process may continue to step 1108.

At step 1108, the ultrasonic acoustic performance of the vent hole configurations is determined. For example, prototype or production parts may be tested, and/or simulations may be performed, to determine ultrasonic acoustic performance for vent hole configurations having suitable robustness to applied pressure bursts. Analysis of ultrasonic acoustic performance can also include consideration of different vent hole locations (e.g., radial distance from a center point in an example of a circular membrane). Once the ultrasonic acoustic performance of the vent hole configurations has been determined, the design process may continue to step 1110.

At step 1110, one of the vent hole configurations is selected based on the pressure dissipation and ultrasonic acoustic performance of the vent hole configurations. As described herein, the selection of vent hole configurations may be based on a variety of factors, such as likely end-use application and manufacturing cost. By utilizing the systems and methods described herein, multiple vent hole configurations may potentially satisfy a design criterion, resulting in high quality ultrasonic acoustic performance while maintaining robustness to applied pressure burst conditions. Once the vent hole configuration has been selected, the design process may end.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A piezoelectric micromachined ultrasonic transducer (PMUT) robust to an applied pressure, comprising:
a membrane including a first electrode layer, a second electrode layer, and a piezoelectric layer between the first electrode layer and the second electrode layer, the membrane comprising:
an active region configured to cause the piezoelectric layer to transmit a first ultrasonic acoustic signal based on a first electrical signal between the first electrode layer and the second electrode layer, and configured to output a second electrical signal corresponding to the first electrode layer and the second electrode layer based on a second ultrasonic acoustic signal received by the piezoelectric layer; and
at least one inactive region where the first electrical signal is not applied to the piezoelectric layer; and
a plurality of vent holes that extend through the membrane and located within the at least one inactive region, wherein the plurality of vent holes balance robustness to the applied pressure and a desired ultrasonic acoustic output.

2. The PMUT of claim 1, wherein the membrane has a center point and wherein each vent hole of the plurality of vent holes is located external to the center point.

3. The PMUT of claim 2, wherein the at least one inactive region comprises a plurality of inactive regions, and wherein a first vent hole of the plurality of vent holes is located within a first inactive region of the plurality of inactive regions and a second vent hole of the plurality of vent holes is located within a second inactive region of the plurality of inactive regions.

4. The PMUT of claim 3, wherein the first vent hole and the second vent hole are located equidistant from the center point.

5. The PMUT of claim 4, wherein the first inactive region and the second inactive region have a same shape and are located equidistant from the center point.

6. The PMUT of claim 5, wherein each of the first inactive region and the second inactive region comprise a portion of an annular ring about the center point having an inner radius and an outer radius.

7. The PMUT of claim 6, wherein the first vent hole is located within the first inactive region at a distance halfway between the inner radius and the outer radius and wherein the second vent hole is located within the second inactive region at the distance.

8. The PMUT of claim 6, wherein each of the first vent hole and the second vent hole are circular.

9. The PMUT of claim 8, wherein a first diameter of the first vent hole and a second diameter of the second vent hole are a same diameter.

10. The PMUT of claim 8, wherein the active region has a circular shape.

11. The PMUT of claim 8, wherein the active region has a non-circular shape.

12. The PMUT of claim 5, wherein the first inactive region and the second inactive region each have a shape other than an annular ring.

13. The PMUT of claim 12, wherein the first vent hole and the second vent hole each have a first non-circular shape.

14. The PMUT of claim 13, wherein the active region has a second non-circular shape.

15. The PMUT of claim 5, wherein the first vent hole and the second vent hole each have a first non-circular shape.

16. The PMUT of claim 1, wherein the at least one inactive region comprises a plurality of inactive regions, and wherein each vent hole of the plurality of vent holes is located within a separate inactive region of the plurality of inactive regions.

17. The PMUT of claim 16, wherein the plurality of inactive regions are evenly distributed about a center point of the membrane and the plurality of vent holes are evenly distributed about the center point.

18. The PMUT of claim 1, wherein one or more of the at least one inactive region comprises a removed region, wherein the first electrode layer, the second electrode layer, and the piezoelectric layer are removed within the removed region.

19. The PMUT of claim 18, wherein the membrane further comprises a structural layer, wherein the structural layer is present in the removed region, and wherein at least one of the plurality of vent holes extend through the structural layer within the removed region.

20. The PMUT of claim 19, wherein all of the plurality of vent holes are located within the removed region, and wherein all of the plurality of vent holes extend through the structural layer within the removed region.

21. The PMUT of claim 1, wherein at least two of the plurality of vent holes are located in a single inactive region.

22. A piezoelectric micromachined ultrasonic transducer (PMUT) robust to an applied pressure, comprising:
a membrane including a first electrode layer, a second electrode layer, and a piezoelectric layer between the first electrode layer and the second electrode layer, wherein the piezoelectric layer transmits a first ultrasonic acoustic signal based on a first electrical signal between the first electrode layer and the second electrode layer, and outputs a second electrical signal to the first electrode layer and the second electrode layer based on a second ultrasonic acoustic signal received by the piezoelectric layer; and
a plurality of vent holes that extend through the membrane, wherein a quantity of the plurality of vent holes, a location of each of the plurality of vent holes, and an area of each of the plurality of vent holes is selected to balance robustness to the applied pressure and a desired ultrasonic acoustic output.

23. A method for designing a piezoelectric micromachined ultrasonic transducer (PMUT) robust to an applied pressure, comprising:
defining a structure of a membrane for transmitting an ultrasonic acoustic signal having a desired ultrasonic acoustic signal strength;
determining, for the desired ultrasonic acoustic signal strength, a plurality of initial vent hole configurations, wherein each initial vent hole configuration of the plurality of initial vent hole configurations comprises a number of vent holes and an area of each of the vent holes;
determining, for each initial vent hole configuration, an applied pressure robustness;
determining, for each of the initial vent hole configuration, an ultrasonic acoustic performance value, wherein each ultrasonic acoustic performance value is based on a respective distance of the vent holes of a respective initial vent hole configuration from a predetermined location within the membrane; and
selecting, from the initial vent hole configurations, a final vent hole configuration based on the respective robustness to applied pressure and the respective ultrasonic acoustic performance values, wherein the final vent hole configuration includes a final number of the vent holes and a final area of the vent holes selected from one of the initial vent hole configurations and a final distance from the predetermined location based on one of the respective distances.
